(19) United States
(12) Patent Application Publication
(10) Pub. No.: US 2005/0108054 A1
(43) Pub. Date: May 19, 2005

(54) Method and apparatus for handwriting recognition

(76) Inventor: Meir Gottlieb, Baltimore, MD (US)

Correspondence Address: GOTTLIEB RACKMAN & REISMAN PC, 270 MADISON AVENUE, 8TH FLOOR, NEW YORK, NY, 100160601, US

(21) Appl. No.: 10/981,116

(22) Filed: Nov. 4, 2004

Related U.S. Application Data
(60) Provisional application No. 60/517,209, filed on Nov. 4, 2003.
(60) Provisional application No. 60/536,373, filed on Jan. 14, 2004.

(51) Int. Cl. G06F 17/60

(52) U.S. Cl. 705/2

(57) ABSTRACT

A PC tablet or similar device is used to generate a patient diagnosis. A doctor or other health provider writes a diagnosis on the device. A known handwriting algorithm is used to convert the written phrase into a sequence of words. Two lists are also provided, one containing words commonly used in medical diagnoses and the other containing actual diagnoses. The two lists are used to generate a diagnosis which is presented to the provider.

### RELATED APPLICATIONS

This application claims priority to provisional application Ser. No. 60/517,209 filed Nov. 4, 2003 and Ser. No. 60/536,373 filed Jan. 14, 2004 and incorporated herein by reference.

### BACKGROUND OF THE INVENTION

A. Field of Invention

This invention pertains to a method and apparatus for generating patient diagnoses electronically, from a handwritten phrase of a user.

B. Description of the Prior Art

One of the biggest challenges in implementing a physician billing system is getting the doctor to specify the diagnosis code for the charge. The diagnosis codes use a classification system known as ICD9 (International Classification of Diseases 9^{th} Revision). The structure and wording of the ICD9 is more designed for billing and not clinical medicine so doctors find it unintuitive to use the ICD9 system.

There is a system known as MEDCIN (available from Medicomp Systems, Inc. 14500 Avion Parkway, Suite 175, Chantilly, Va. 20151) that provides a clinically relevant medical nomenclature, an algorithm for searching that nomenclature and a cross-link table to go from the MEDCIN terminology to the ICD9 code set. In that way, a doctor can search the MEDCIN database and find the appropriate ICD9 code.

However, it has been found that using MEDCIN on a portable data entry device such as tablet PC is difficult because it requires a doctor or other health professional to type-out the diagnosis using a keyboard and this process is very time-consuming. Moreover, typical handwriting algorithms work by first having a person write something (preferably using an electronic media, such as the touch screen on a tablet), analyzing the handwritten phrase, performing a guessing algorithm that uses complex character recognition algorithms to find a family of the closest alphanumeric characters. The family is then presented to the person, and the person has to recognize the alphanumeric characters that correspond to his handwriting phrase. However, in many instances this process is too tedious to be practical. For example, when a doctor performs an examination and then writes on a tablet a search phrase for Medcin, a recognition algorithm must be performed on the doctor's handwriting and then the doctor must fix the recognition errors before performing the MEDCIN search is time-consuming and disruptive.

### SUMMARY OF THE INVENTION

Briefly, an apparatus is presented having a touch screen, a processor, one or more control keys, and a handwriting recognition module. A user, such as physician, or other health care provider, writes a diagnosis on the touch screen, the diagnosis consisting of a phrase of several words. The module converts the words into known alphanumeric characters. A fuzzy logic algorithm is used to compare the converted words to words from a vocabulary of medical terms and to generate corresponding groups of candidate words. The resulting groups are then compared to known medical diagnoses and the diagnoses that match these groups are displayed to the user. The user can then select the proper diagnosis.

The diagnosis is then sent to a central data bank for archiving, bill generating, or other purposes.

### BRIEF DESCRIPTION OF THE DRAWINGS

FIG. 1 shows a block diagram of an apparatus, such as a PC tablet for entering diagnoses;

FIG. 2 shows a general flow chart of the method of entering diagnoses in accordance with this invention; and

FIG. 3 shows a detailed flow chart of the operation of the apparatus of FIG. 1.

### DETAILED DESCRIPTION OF THE INVENTION

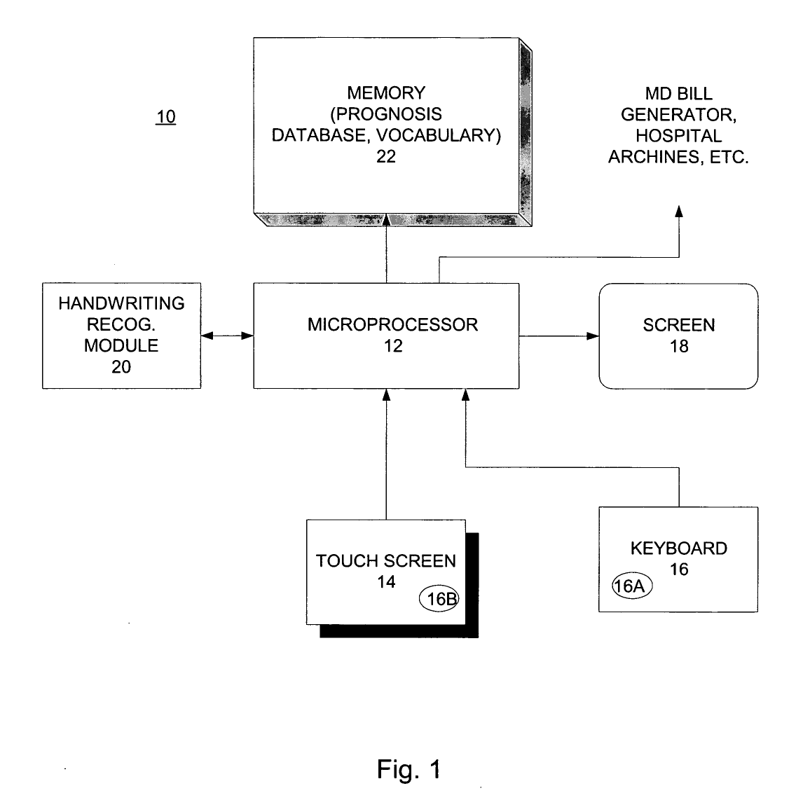

An apparatus 10 constructed in accordance with this invention is shown in FIG. 1. The apparatus 10 may be a PC tablet or other similar data entry device on which a user, such as a physician or other health care provider, can enter information and it includes a microprocessor 12 receiving inputs, including data and commands, from a touch screen 14 or a keyboard 16, including a key 16A. Instructions and other information is presented on a screen 18. At least some of the keys of the apparatus 10 (such as 16B) may be virtual keys presented on the touch screen 14, however, in FIG. 1 the keyboard is shown as a separate element for the sake of clarity.

The apparatus 10 further includes a hand writing recognition module 20 that is used to analyze handwriting on the screen 14 and recognize the same as a sequence of alphanumeric characters forming words. The module 20 is a separate and discrete element of the apparatus 10 or it may be implemented by software.

Finally, a memory 22 is used to hold a vocabulary consisting of list of words used to define or otherwise associated with patient diagnoses, and a list of diagnoses. Alternatively, the memory may only be used to store a list of diagnoses.

In another embodiment of the invention, the vocabulary and the list of diagnoses are stored in a central location or some other site and accessed by the device 10 when required.

Of course, the memory 22 may also be used for other purposes as well. For example, the memory may be used to hold software operating the microprocessor 12.

Briefly, the apparatus may be used to in a hospital or other health care facility to enter patient information. For example, in one scenario, a doctor or other service provider enters data on the apparatus 10 at a patient's bed side, in a lab, in an operating room, or other similar sites. Once the information is completed, it is entered into a master database (not shown) which is sent as a part of patient encounter file to a coder station (not shown). At the coder station, a coder reviews the information comes up work a working DRG. If the coder has any questions for the doctor to clarify, the coder sends a query to physician. Once the patient is discharged, the coder generates a hospital bill that is forwarded to a bill processing agent. Details of this scenario are found in co-pending application Ser. No. 60/536,373 filed Jan. 14, 2004 and corresponding U.S. application Ser. No. ______ filed ______. The data collected from the apparatus 10 may be used for other purposes as well.

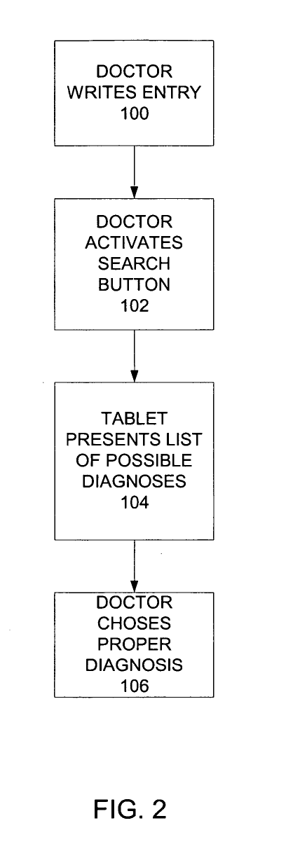

Returning to FIG. 2, the doctor writes the diagnosis in his/her own handwriting on the touch screen 14 (FIG. 2, step 100) and then activates a pushbutton (e.g. 16A-step 102) indicating that the search can be initiated. Alternatively, the search can be initiated on the fly, i.e., as soon as a word is recognized. The microprocessor 12 reads the handwriting, searches the database(s) in memory 22 and presents on the screen 18 a list of possible diagnoses (Step 104). The doctor selects the proper diagnosis from the list (Step 106) and the data entry is completed. After step 102 the process may take only a fraction of a second.

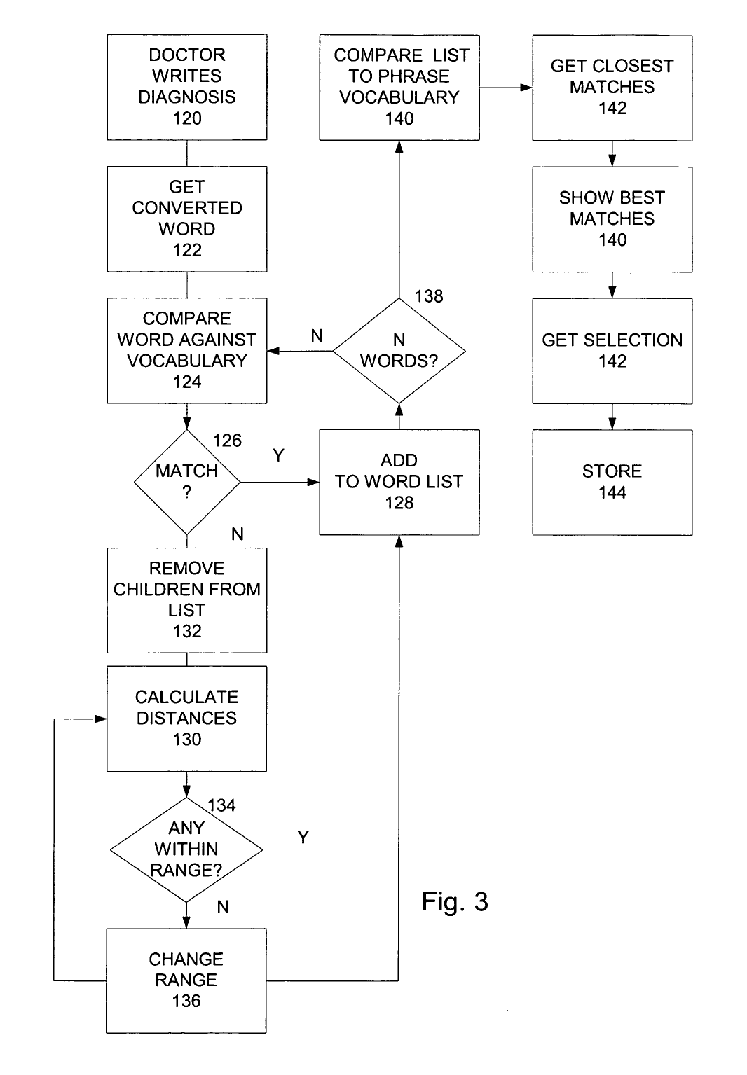

Details of the algorithm used to generate the list of possible diagnoses of step 104 is shown in FIG. 3. The doctor writes a phrase of several words in step 120 (identical to steps 100, 102 in FIG. 2). In step 122 the handwriting recognition module detects and recognize the first word of the phrase. A search is then performed within the vocabulary in memory 22 to identify all the medical terms or words that either match or are similar to the recognized word.

The vocabulary of memory 22 includes medical nomenclature used by standard diagnoses. These diagnoses are well known in the medical field. For example, diagnoses have been codified in the ICD-9 code set. In one embodiment, the vocabulary is obtained by compiling a list of the words from the ICD-9 code set. Alternatively, as discussed above, only the list of diagnoses is stored in the memory, and a word recognized by the module 20 is the compared to the words comprising the diagnoses.

Returning to FIG. 3, in step 124, a converted word is compared to the words in the vocabulary (or the words in the list of diagnoses). In step 126 a decision is made as to whether the converted word matches one of the vocabulary words, or not. This step is required because the handwriting recognition module 20 may not work perfectly and could make mistake that would prevent the algorithm from finding exact matches. Therefore, if a matching word is found, then in step 128 it is added to a new list.

If no match is found in step 126, then a fuzzy logic process is used to identify words that are close to the converted word and therefore may be the words written by the user. More specifically, in step 130 the converted word is compared to words of the vocabulary that are close. Closeness is determined by the edit distance from the converted word to each of these words. The edit distance (or, more simply, the distance) is defined as the number of edits (insertion, deletion, exchange of letters) that are required to transform the converted word into a word in the vocabulary. For example, the user may write “heart attack” and the first converted word recognized (because of inherent errors in the software) is ‘hean’. Since ‘hean’ is not in the vocabulary, its respective edit distances to other words is determined in step 130. These words form a temporary list that may include the following, with the numbers in the parentheses indicating the respective edit distance:
Head (1)
Heads(2)
Hear(1)
Heat(1)
Heats(2)
Heard(2)
Hears(2)
Heart(2)
Hearts(3)

Next, in step 132 “children”, such as heads, heats, hearts heard are eliminated from the temporary list.

Next, in step 134 the edit distance is analyzed to determine if it is within a preselected range. Preferably, the preselected range is determined a function of the number of letters L in a word. For example, the range R may be defined as:
R=L(1−P/100)
where P is a programming parameter expressed in percentage. It has been found that an initial value of P that works well is 70. Thus, for a word of nine letters (e.g., laughing) R=3 when rounded off. For a four letter word such as “hean”, R=1.

Getting back to FIG. 3, in step 134 it is determined whether any words have been detected that are a within a edit distance of R from the converted word. Any words within this range are added to the list in step 128.

If no words are found in step 136 then parameter 70 is reduced by an incremental amount, for example, 5. The parameter R is then recalculated and step 134 is repeated. Steps 134, 136 are repeated several times, if necessary, until at least one word is found.

Once a list of candidate words matching the converted word are found, then in step 138 a check is performed to determine if the handwriting recognition module has converted all the words written on the touch screen 14. If there are more words to be converted, then the processing of the next converted word is started in step 124.

If all words are converted, a list is generated with all diagnoses that contain any of the converted words. This is done quickly by checking a pre-generated cross reference table that lists all vocabulary words for each diagnosis.

These diagnoses are displayed in step 138. It has been found in many instances only a single diagnosis is found. This diagnosis is shown in step 140 and the doctor then accepts it and the diagnosis is stored and processed as discussed above. If several diagnoses are identified in step 140, then they are all shown to the doctor. The doctor selects the proper diagnosis. The doctor's choice is obtained in step 142 and processed and stored in step 144.

Numerous modifications may be made to this invention without deprating from its scope, as defined in the attached claims.

1. An apparatus generating information related to patient diagnosis comprising:
a data entry element sensing a handwritten phrase from a user;
a data storage including a first list formed of common medical terms and a second list formed of phrases of several words, each phrase defining a patient diagnosis; and
a processor adapted to receive a plurality of converted words corresponding to said handwritten phrase, said processor generating a patient diagnosis based on the comparison of said plurality of words to said first and second list.

2. The apparatus of claim 1 further comprising a handwriting recognition module that analyzes said written phrase and generates in response said converted words.

3. The apparatus of claim 1 further comprising a screen used to display said diagnosis to the health care provider.

4. The apparatus of claim 3 further comprising a selection member operable by a health provide to selectively accept said diagnosis.

5. A method of generating a patient diagnosis using a data entry device, comprising the steps of:
receiving a handwritten phrase from a health provider;
converting said handwritten phrase into a sequence of converted words, said sequence including at least a first converted word and a second converted word;
comparing said first and a second converted word to a list of words commonly used in medical diagnosis;
obtaining a first plurality of words from said list associated with said first converted word and a second plurality of words from said list associated with said second converted word;
generating word grooups, each word group including a word from at least each of said first and second plurality of words;
comparing word groups to phrases from a list of phrases, each phrase forming a known diagnosis; and
selecting one of said phrases as the diagnosis.

6. The method of claim 5 further comprising obtaining a third converted word.

7. The method of claim 5 wherein said one phrase is selected using fuzzy logic.

8. The method of claim 5 further comprising presenting the patient diagnostic to said health provider.

9. The method of claim 8 further comprising providing several diagnoses to said health provider, said health provider selecting one of said diagnoses as corresponding to the patient.

10. An apparatus for generating a patient diagnosis by a health care provider comprising:
means for receiving written phrases from said health care provider;
means for converting said written phrases into converted words;
a comparator comparing said converted words to entries of a list to generate a first set of words and a second set of words corresponding to said first and second converted words, respectively;
a second comparator comparing groups of said first and second words to entries in a list of diagnoses; and
a selector that selects an entry from said list of diagnoses as being descriptive of the patient's condition.

11. The apparatus of claim 10 wherein said means for receiving includes a touch screen.

12. The apparatus of claim 11 wherein said touch screen is adapted to display data.

13. The apparatus of claim 12 wherein said touch screen is adapted to display said diagnosis.

14. The apparatus of claim 10 further comprising data storage means storing said list of words and said list of diagnoses.

15. the apparatus of claim 10 wherein said apparatus is a hand-held device.

16. The apparatus of claim 15 further comprising a memory storing said lists.

17. The apparatus of claim 15 further comprising communication means arranged to receive said list from a remote data storage facility.
